(19) United States
(12) Patent Application Publication
(10) Pub. No.: US 2015/0334051 A1
(43) Pub. Date: Nov. 19, 2015

(54) SERVER

(71) Applicants: Inventec (Pudong) Technology Corporation, Shanghai (CN); INVENTEC CORPORATION, Taipei City (TW)

(72) Inventor: Lan-Lan FANG, SHANGHAI (CN)

(21) Appl. No.: 14/328,837

(22) Filed: Jul. 11, 2014

(30) Foreign Application Priority Data
May 14, 2014 (CN) 201410203425.2

(51) Int. Cl. H04L 12/933

(52) U.S. Cl. CPC H04L 49/102

(57) ABSTRACT

A server includes at least one computing board and a baseboard. The computing board includes a plurality of system on chips and a plurality of network interface controllers. The system on chips are used for transceiving at least one differential signal. Each of the network interface controllers is used for performing conversion between the differential signal and a signal between network media access control layer and physical layer. The baseboard includes at least one switch module for switching and transceiving a signal, at least one first physical layer transceiver for performing the conversion between the signal between network media access control layer and physical layer and a first network connector signal and at least one first network connector.

### RELATED APPLICATIONS

This application claims priority to Chinese Application Serial Number 201410203425.2, filed May 14, 2014, the entirety of which is herein incorporated by reference.

### BACKGROUND

1. Technical Field

The present disclosure relates to a server. More particularly, the present disclosure relates to a server, which can be managed remotely.

2. Description of Related Art

As the development of electronic technology, the computing ability of servers is more and more powerful. With the growing popularity, multiple independent system on chips are allowed to be installed in a single server to perform different applications, such as a media player, database management, voice recognition, ID authentication, website service and so on.

However, due to the limitations of manufacturing cost and accommodating space for a server, it is not able to provide each system on chip in the server with an independent network connector. Therefore, a server manager may be difficult to remotely control specific system on chips through a network.

### SUMMARY

In one aspect, the present disclosure is related to a server. The server includes at least one computing board and a baseboard. Each of the at least one computing board includes a plurality of system on chips and a plurality of network interface controllers. Each of the system on chips is used for transceiving at least one differential signal. Each of the network interface controllers is electrically connected with a corresponding system chip of the system on chips. Each of the network interface controllers is used for performing conversion between the at least one differential signal and at least one signal between network media access control (MAC) layer and physical (PHY) layer. The baseboard is electrically connected with the at least one computing board. The baseboard includes at least one switch module, at least one first physical layer transceiver and at least one first network connector. The at least one switch module is electrically connected with the network interface controllers. The at least one switch module is used for switching and transceiving a signal selected from the group consisting of the signal between network media access control layer and physical layer converted by each of the network interface controllers. The at least one first physical layer transceiver is electrically connected with the at least one switch module. The at least one first physical layer transceiver is used for performing conversion between the signal between network media access control layer and physical layer transceived by the at least one switch module and a first network connector signal. The at least one first network connector is electrically connected with the at least one first physical layer transceiver. The at least one first network connector is used for transceiving the first network connector signal such that a user can manage and control the system on chips through the first network connector signal.

According to one embodiment of the present disclosure, the number of the at least one differential signal, of the at least one signal between network media access control layer and physical layer, of the at least one switch module, of the at least one first physical layer transceiver, and of the at least one first network connector are plural. Each of the network interface controllers is further used for transceiving the signals between network media access control layer and physical layer to corresponding switch modules. Each of the switch modules is used for switching and transceiving a signal selected from the group consisting of the received signals between network media access control layer and physical layer.

According to another embodiment of the present disclosure, the at least one computing board further includes a management controller and a second physical layer transceiver. The management controller is used for transceiving a network physical layer signal. The second physical layer transceiver is electrically connected with the management controller. The second physical layer transceiver is used for performing conversion between the network physical layer signal and a second network connector signal. The baseboard further includes a second network connector. The second network connector is electrically connected with the second physical layer transceiver. The second network connector is used for transceiving the second network connector signal, so as to the user manage and control the management controller through the second network connector signal.

According to another embodiment of the present disclosure, the management controller is a baseboard management controller, and the management controller is used for receiving at least one command through the second network connector signal to manage the server.

According to another embodiment of the present disclosure, the differential signal a PCI Express signal, and each of the network interface controllers is electrically connected with the corresponding system on chip through a PCI Express bus

According to another embodiment of the present disclosure, each of the at least one computing board is electrically connected with the baseboard through a corresponding gold finger connector slot.

According to another embodiment of the present disclosure, the at least one signal between network media access control layer and physical layer is a serial gigabit media independent interface signal, and each of the network interface controllers are electrically connected with the at least one switch module through a serial gigabit media independent interface.

According to another embodiment of the present disclosure, the network physical layer signal is a media independent interface signal, and the management controller is electrically connected with the second physical layer transceiver through a media independent interface.

According to another embodiment of the present disclosure, the first network connector signal is a base band signal.

According to another embodiment of the present disclosure, the number of the at least one computing board is plural. The at least one switch module is used for selecting one of the computing boards, and for switching and transceiving the signal of the selected computing board according to a user command and firmware settings of the at least one switch module. The corresponding network interface controller transceives the signal on the selected computing board being used for converting the signal to the differential signal, and for transmitting the differential signal to the corresponding system on chip.

By applying the techniques disclosed in the present disclosure, a server manager can remotely manage any system on chip on the computing board or any management controller in the server. The server manager does not need to arrive the spot of the server. The server manager can manage any system on chip through a network connector. Moreover, the server manager can manage multiple servers without having to provide each server with an independent keyboard, a mouse or a monitor.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows.

FIG. 1 is a block diagram of a server in accordance with one embodiment of the present disclosure;

FIG. 2 is a block diagram of a computing board and a baseboard in accordance with one embodiment of the present disclosure;

FIG. 3 is a block diagram of a computing board and a baseboard in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

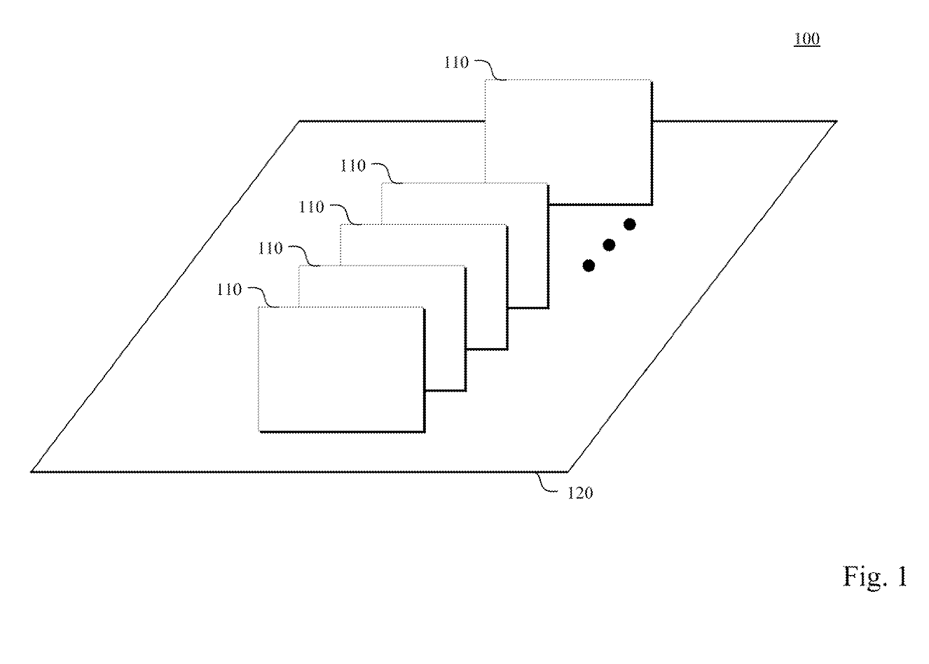

Reference is made first to FIG. 1. FIG. 1 is a block diagram of a server 100 in accordance with one embodiment of the present disclosure. The server 100 includes at least one computing board 110 (in this embodiment, the number of the computing boards 110 is plural) and a baseboard 120. Each of the at least one computing boards 110 includes a plurality of system on chips (not depicted). A user can select and manage one or more abovementioned system on chips (the system on chips selected by the user are not limited to be on the same computing board). In an embodiment of the present disclosure, the server 100 includes 45 computing boards, and each of the computing boards includes 4 system on chips. In another embodiment of the present disclosure, each of the at least one computing board 110 is electrically connected with the baseboard 120 through a corresponding gold finger connector slot.

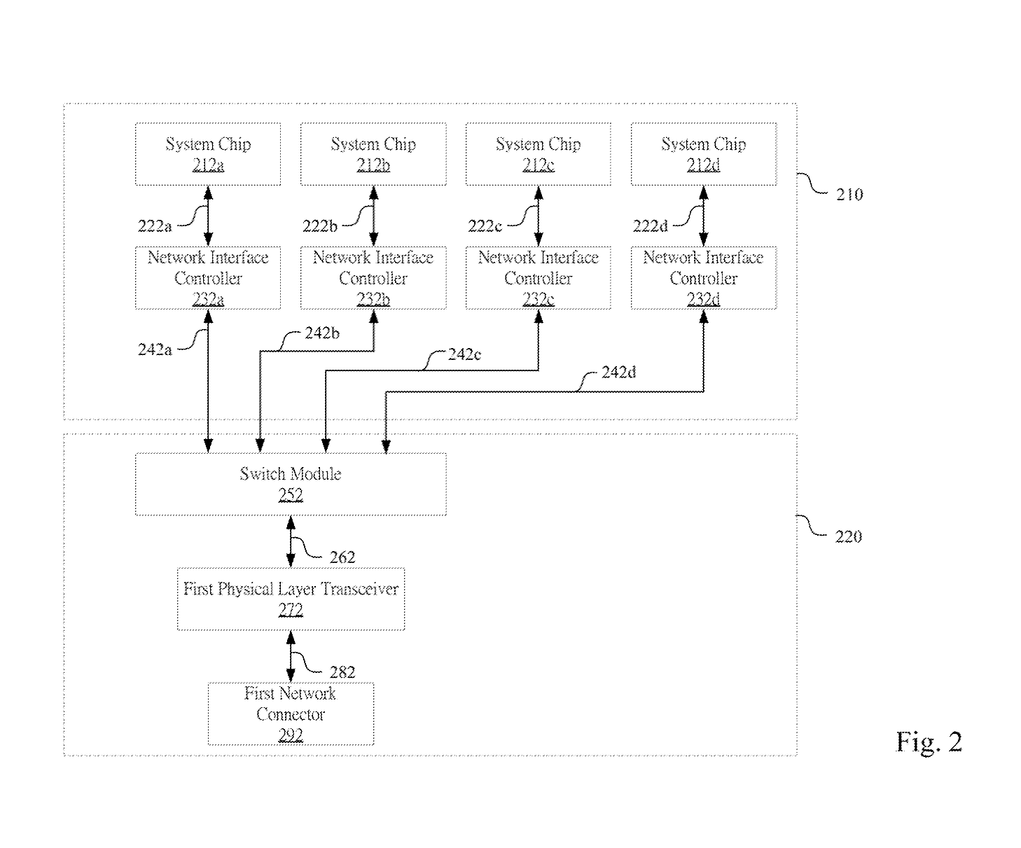

Reference is made also to FIG. 2. FIG. 2 is a block diagram of a computing board 210 and a baseboard 220 in accordance with one embodiment of the present disclosure. The computing board 210 can be one of the computing boards 110 illustrated in FIG. 1 but not limited herein. The baseboard 220 can be the baseboard 120 illustrated in FIG. 1 but is not limited herein. In the following paragraph, the structure of the computing board 210 will be further explained.

In this embodiment, the computing board 210 includes four system on chips 212a, 212b, 212c and 212d) and four network interface controllers (232a, 232b, 232c and 232d). In an embodiment of the present disclosure, the system on chips 212a, 212b, 212c and 212d are system on chips (SOCs).

It has to be explained that in the present disclosure, the number of the abovementioned system on chips is not limited to four, and the number of the abovementioned network interface controllers is not limited to four, either. In another embodiment of the present disclosure, the structure of a computing board is similar to the structure of the computing board 210, and the computing board in that embodiment includes five system on chips and five network interface controllers.

As illustrated in FIG. 2, the system on chips 212a, 212b, 212c and 212d are used for transceiving differential signals 222a, 222b, 222c and 222d, respectively.

Network interface controllers 232a, 232b, 232c and 232d are electrically connected with the system on chips 212a, 212b, 212c and 212d, respectively. The network interface controller 232a is used for performing conversion between the differential signal 222a and a signal between network media access control (MAC) layer and physical (PHY) layer 242a. The network interface controller 232b is used for performing conversion between the differential signal 222b and a signal between network media access control layer and physical layer 242b. The network interface controller 232c is used for performing conversion between the differential signal 222c and a signal between network media access control layer and physical layer 242c. The network interface controller 232d is used for performing conversion between the differential signal 222d and a signal between network media access control layer and physical layer 242d.

In an embodiment of the present disclosure, the differential signals 222a, 222b, 222c and 222d are PCI Express signals. The network interface controllers 232a, 232b, 232c and 232d are electrically connected with the system on chips 212a, 212b, 212c and 212d through PCI Express buses, respectively.

As illustrated in FIG. 2, the baseboard 220 includes a switch module 252, a first physical layer transceiver 272 and a first network connector 292.

The switch module 252 is electrically connected with the network interface controllers 232a, 232b, 232c and 232d. The switch module 252 is used for selecting, for example, one of the computing boards 110 as illustrated in FIG. 1 (for the convenience of illustration, the computing board 210 is assumed here to be the selected computing board) according to a user command (not depicted) and firmware settings of the switch module 252. The switch module 252 is also used for switching and transceiving a signal selected from the group consisting of the signals converted by the network interface controllers 232a, 232b, 232c and 232d (i.e., the signals between network media access control layer and physical layer 242a, 242b, 242c and 242d) of the selected computing board 210 according to the abovementioned user command and the abovementioned firmware settings of the switch module 252.

In another embodiment of the present disclosure, the signals between network media access control layer and physical layer 242a, 242b, 242c and 242d are serial gigabit media independent interface signals. Each of the network interface controllers 232a, 232b, 232c and 232d is electrically connected with the switch module 252 through a serial gigabit media independent interface.

In the present embodiment, the first physical layer transceiver 272 is electrically connected with the switch module 252. The first physical layer transceiver 272 is used for performing conversion between the signal between network media access control layer and physical layer 262 transceived by the switch module 252 and a first network connector signal 282. In an embodiment of the present disclosure, the first network connector signal 282 is a base band signal.

The first network connector 292 is electrically connected with the first physical layer transceiver 272. The first network connector 292 is used for transceiving the first network connector signal 282 such that a user can manage and control the system on chips 212a, 212b, 212c and 212d through the first network connector signal 282. In an embodiment of the present disclosure, the first network connector 292 is a RJ45 network connector.

It has to be explained that in the disclosed server, each of the system on chips can be used for transmitting a plurality of differential signals, and the number of the switch modules on the baseboard can be plural. In the following embodiment, each of the system on chips is used for transmitting two differential signals, and the number of the switch modules on the baseboard is two. Each of the switch modules is used for switching and transceiving a signal selected from the group consisting of the received signals between network media access control layer and physical layer.

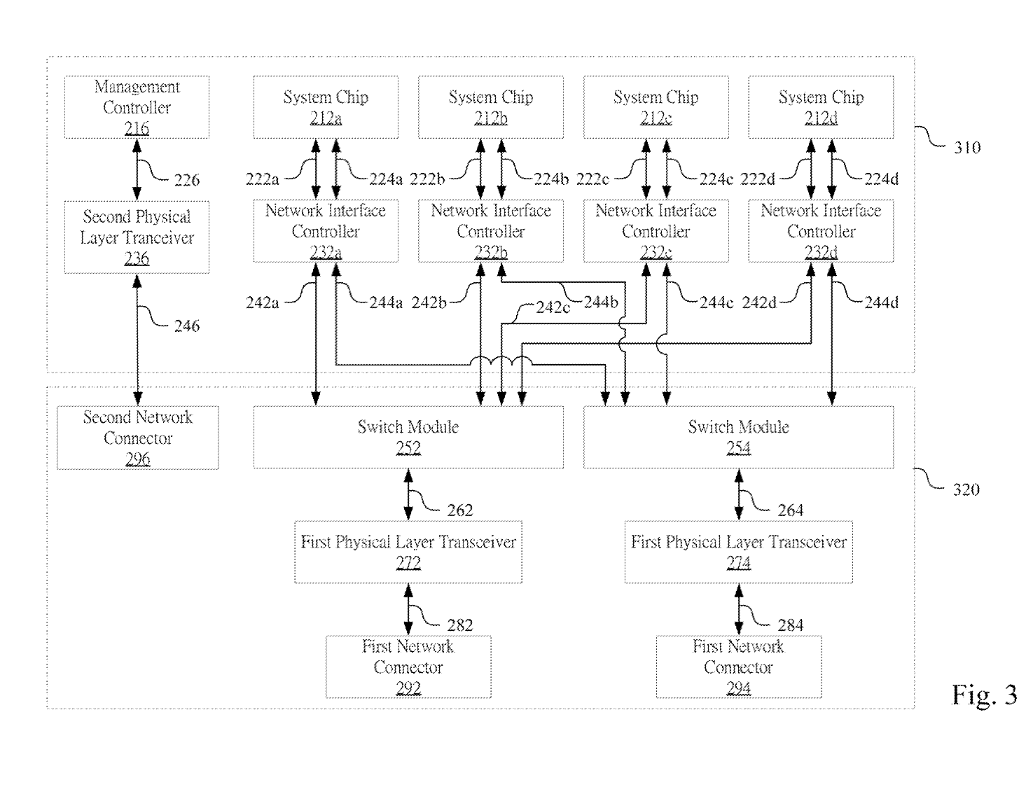

Additional reference is made to FIG. 3. FIG. 3 is a block diagram of a computing board 310 and a baseboard 320 in accordance with one embodiment of the present disclosure. The computing board 310 can be one of the computing boards 110 illustrated in FIG. 1 but not limited herein. The baseboard 320 can be the baseboard 120 illustrated in FIG. 1 but is not limited herein.

Compared with the computing board 210 illustrated in FIG. 2, in the computing board 310 illustrated in this embodiment, the system on chips 212a, 212b, 212c and 212d are further used for transceiving the differential signals 224a, 224b, 224c and 224d.

The network interface controller 232a is further used for performing conversion between the differential signal 224a and the signal between network media access control layer and physical layer 244a. The network interface controller 232b is further used for performing conversion between the differential signal 224b and the signal between network media access control layer and physical layer 244b. The network interface controller 232c is further used for performing conversion between the differential signal 224c and the signal between network media access control layer and physical layer 244c. The network interface controller 232d is further used for performing conversion between the differential signal 224d and the signal between network media access control layer and physical layer 244d.

Moreover, in the present embodiment, the computing board 310 further selectively includes a management controller 216 and a second physical layer transceiver 236. In an embodiment of the present disclosure, the management controller 216 is a baseboard management controller, which is used for receiving at least one command through the second network connector signal 246 to manage the server. It has to be explained that the second physical layer transceiver 236 and the first physical layer transceiver 272 illustrated in FIG. 2 can be two different components.

The management controller 216 is used for transceiving a network physical layer signal 226. The second physical layer transceiver 236 is electrically connected with the management controller 216. The second physical layer transceiver 236 is used for performing conversion between the network physical layer signal 226 and a second network connector signal 246. In an embodiment of the present disclosure, the network physical layer signal 226 is a media independent interface signal. The management controller 216 is electrically connected with the second physical layer transceiver 236 through a media independent interface.

Compared with the baseboard 220 illustrated in FIG. 2, in the present embodiment, the baseboard 320 further includes a switch module 254, a first physical layer transceiver 274 and a first network connector 294. Moreover, in this embodiment, the baseboard 320 further selectively includes a second network connector 296.

The switch module 254 is electrically connected with the network interface controllers 232a, 232b, 232c and 232d. The functions and operations of the switch module 254 and of the switch module 252 are similar. The switch module 254 is used for selecting, for example, one of the computing boards 110 as illustrated in FIG. 1 (for the convenience of illustration, the computing board 310 is assumed here to be the selected computing board) according to a user command and firmware settings of the switch module 254. The switch module 254 is also used for switching and transceiving a signal selected from the group consisting of the signals converted by the network interface controllers 232a, 232b, 232c and 232d (i.e., the signals between network media access control layer and physical layer 244a, 244b, 244c and 244d) of the selected computing board 310 according to the abovementioned user command and the abovementioned firmware settings of the switch module 254.

The first physical layer transceiver 274 is electrically connected with the switch module 254. The functions and operations of the first physical layer transceiver 274 and of the first physical layer transceiver 272 are similar. The first physical layer transceiver 274 is used for performing conversion between the signal between network media access control layer and physical layer 264 transceived by the switch module 254 and a first network connector signal 284.

The first network connector 294 is electrically connected with the first physical layer transceiver 274. The functions and operations of the first network connector 294 and of the first network connector 292 are similar. The first network connector 294 is used for transceiving the first network connector signal 284.

The second network connector 296 is electrically connected with the second physical layer transceiver 236. The second network connector 296 is used for transceiving the second network connector signal 246 such that the user can manage and control the management controller 216 through the second network connector signal 246. In an embodiment of the present disclosure, the second network connector 296 is a RJ45 network connector.

It has to be explained that in the disclosed server, the number of the switch modules on the baseboard is not limited to two. Those skilled can impose multiple switch modules on the baseboard, for example, in a structure similar to that illustrated in FIG. 3, according to practical needs.

According to the above embodiments, a server manager can remotely manage any system on chip on the computing board or any management controller in the server. The server manager does not need to arrive the spot of the server. The server manager can manage any system on chip through a network connector. Moreover, the server manager can manage multiple servers without having to provide each server with an independent keyboard, a mouse or a monitor.

The above illustrations include exemplary operations, but the operations are not necessarily performed in the order shown. Operations may be added, replaced, changed order, and/or eliminated as appropriate, in accordance with the spirit and scope of various embodiments of the present disclosure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A server, comprising:
at least one computing board, wherein each of the at least one computing board comprises:
a plurality of system on chips, wherein each of the system on chips is used for transceiving at least one differential signal; and
a plurality of network interface controllers, wherein each of the network interface controllers is electrically connected with corresponding system on chip of the system on chips, and each of the network interface controllers is used for performing conversion between the at least one differential signal and at least one signal between network media access control (MAC) layer and physical (PHY) layer; and
a baseboard, electrically connected with the at least one computing board, the baseboard comprising:
at least one switch module, electrically connected with the network interface controllers, the at least one switch module being used for switching and transceiving a signal selected from the group consisting of the signal between network media access control layer and physical layer converted by each of the network interface controllers;
at least one first physical layer transceiver, electrically connected with the at least one switch module, the at least one first physical layer transceiver being used for performing conversion between the signal between network media access control layer and physical layer transceiver by the at least one switch module and a first network connector signal; and
at least one first network connector, electrically connected with the at least one first physical layer transceiver, the at least one first network connector being used for transceiving the first network connector signal, so as to enable a user to manage and control the system on chips through the first network connector signal.

2. The server of claim 1, wherein the number of the at least one differential signal, of the at least one signal between network media access control layer and physical layer, of the at least one switch module, of the at least one first physical layer transceiver, and of the at least one first network connector are plural;
each of the network interface controllers being further used for transceiving the signals between network media access control layer and physical layer to corresponding switch modules; and
each of the switch modules being used for switching and transceiving a signal selected from the group consisting of the received signals between network media access control layer and physical layer.

3. The server of claim 1, wherein each of the at least one computing board further comprises:
a management controller, used for transceiving a network physical layer signal; and
a second physical layer transceiver, electrically connected with the management controller, the second physical layer transceiver being used for performing conversion between the network physical layer signal and a second network connector signal; and
the baseboard further comprising:
a second network connector, electrically connected with the second physical layer transceiver, the second network connector being used for transceiving the second network connector signal, so that the user manages and controls the management controller through the second network connector signal.

4. The server of claim 3, wherein the management controller is a baseboard management controller, and the management controller is used for receiving at least one command through the second network connector signal to manage the server.

5. The server of claim 1, wherein the differential signal is a PCI Express signal, and each of the network interface controllers being electrically connected with the corresponding system on chip through a PCI Express bus.

6. The server of claim 1, wherein each of the at least one computing board is electrically connected with the baseboard through a corresponding gold finger connector slot.

7. The server of claim 1, wherein the at least one signal between network media access control layer and physical layer is a serial gigabit media independent interface signal, and each of the network interface controllers being electrically connected with the at least one switch module through a serial gigabit media independent interface.

8. The server of claim 3, wherein the network physical layer signal is a media independent interface signal, and the management controller being electrically connected with the second physical layer transceiver through a media independent interface.

9. The server of claim 1, wherein the first network connector signal is a base band signal.

10. The server of claim 1, wherein the number of the at least one computing board is plural;
the at least one switch module being used for selecting one of the computing boards, and for switching and transceiving the signal of the selected computing board according to a user command and firmware settings of the at least one switch module; and
the corresponding network interface controller transceiving the signal on the selected computing board being used for converting the signal to the differential signal, and for transmitting the differential signal to the corresponding system on chip.
